(19) United States
(12) Patent Application Publication
(10) Pub. No.: US 2024/0125611 A1
(43) Pub. Date: Apr. 18, 2024

(54) SYSTEMS AND METHODS FOR OPTIMIZING ROUTES AND WATER USAGE

(71) Applicant: Ford Global Technologies, LLC, Dearborn, MI (US)

(72) Inventors: Robert D. Bedard, Allen Park, MI (US); Douglas Raymond Martin, Canton, MI (US)

(73) Assignee: Ford Global Technologies, LLC, Dearborn, MI (US)

(21) Appl. No.: 18/046,200

(22) Filed: Oct. 13, 2022

(51) Int. Cl. G01C 21/36; G01C 21/34

(52) U.S. Cl. CPC G01C 21/3617; G01C 21/3415; G01C 21/3438; G01C 21/3484

(57) ABSTRACT

Systems and methods for optimizing routes and water usage are disclosed herein. An example method includes determining calendar data for a traveler, the calendar data including trip information for a trip, determining a current water supply for the traveler, determining water generation capability of a vehicle used by the traveler for the trip, predictively determining a water estimate for the trip, determining when the water supply and the water generation capability substantially correspond to the water estimate, and providing an alert to the traveler when the water supply and the water generation capability are insufficient relative to the water estimate.

### CROSS-REFERENCE(S) TO RELATED APPLICATIONS

This application is related to U.S. application Ser. No. 17/865,978, filed on Jul. 15, 2022, which is hereby incorporated by reference herein in its entirety, including all references cited therein for all purposes, as if fully set forth herein.

### BACKGROUND

The ability to generate water in vehicles can vary widely depending on environmental conditions, such as temperature, humidity, altitude, and other ambient conditions. Users may take a supply of water on a trip to supplement the water generation capabilities of their vehicle. However, changes in routes, ambient/weather conditions, and other factors may impact water generating performance.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example environment in accordance with one or more embodiments of the present disclosure.

FIG. 2 illustrates an example flowchart in accordance with one or more embodiments of the present disclosure.

FIG. 3 is a screenshot of an example graphical user interface (GUI) pertaining to a travel route and water generation in accordance with one or more embodiments of the present disclosure.

FIG. 4 is a screenshot of an example map provided on an example GUI that illustrates a group of travelers along a route having vehicles with water generation capabilities in accordance with one or more embodiments of the present disclosure.

FIG. 5 is a screenshot of an example map provided on an example GUI that illustrates an alternative route in accordance with one or more embodiments of the present disclosure.

FIG. 6 illustrates an example flowchart in accordance with one or more embodiments of the present disclosure.

FIG. 7 illustrates an example flowchart in accordance with one or more embodiments of the present disclosure.

### DETAILED DESCRIPTION

### Overview

The present disclosure is directed to systems and methods configured to optimize water usage and generation during trips. Vehicles can be adapted to generate water using various apparatuses and methods. Example water generation systems and methods are disclosed in U.S. application Ser. No. 17/865,978, filed on Jul. 15, 2022, which is incorporated by reference herein. These portable water generating apparatuses can be used to generate potable water while a user travels from their departure to a destination. The systems and methods herein can utilize traveler data and route calculations to determine when a traveler is likely to have enough water for a particular trip. More so, the systems and methods disclosed herein can utilize traveler data and route calculations to provide a recommendation to the user on a trip route in order to optimize water generation by the vehicle and/or water generation components.

Traveler and trip data, referred to as trip information, can be obtained from various information sources, such as user calendar applications, note-taking applications (e.g., cloud-based notes), or any other information source that provides information that is indicative of a traveler's upcoming trip. Trip information can also be obtained from a group of others in a digital community to plan a travel route based on water availability and the possibility to meet members of a digital group (referred to generally as an “Oasis Community”) to share water if desired.

Water generation capability is described in U.S. application Ser. No. 17/865,978, filed on Jul. 15, 2022. The present disclosure leverages the knowledge described in the art and creates a way for the traveler to use their digital calendar and notation application to plan and execute a trip (or trips), including supplies required, and to schedule a meeting among participants that may not know each other.

In certain embodiments, systems and methods that can be used to create and control a mobile water-based oasis community. The community may involve the use of vehicles with water generation systems. Artificial Intelligence (“AI”) and/or Machine Learning (“ML”) can be used to predictively determine a water estimate for the trip. This estimate can be used to determine if the available water supply for the traveler, plus any vehicle-generated water, is sufficient for an upcoming trip. The traveler can be notified when the traveler's water supply and forecasted water generation are not sufficient for the trip. Thus, the traveler can plan accordingly.

The water estimate can be determined from a wide variety of data sources, such as prior historical trips by the traveler or other travelers, and can further involve evaluating road conditions, traffic, weather, and other parameters that may affect travel time or water generation of the vehicle. In some instances, a system of the present disclosure can select an optimized route for the traveler so that the traveler can arrive at their destination with sufficient water. In one example, the system can utilize map data to identify locations where water can be purchased. For example, the system can identify a location of a convenience or grocery store. A route to this location can be identified.

In some instances, the systems and methods herein can be adapted to optimize a number of travelers in a group to prevent water hoarding or other undesirable behaviors. The systems and methods can also detect when a traveler may have excess water, inform the traveler that they have excess water, and allow that traveler to share their water with those in their optimized group.

### Illustrative Embodiments

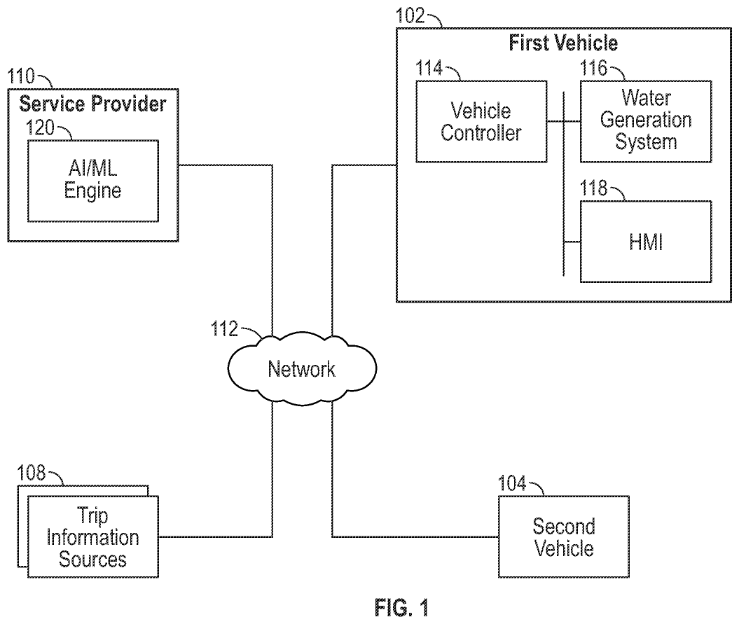

FIG. 1 illustrates an example environment where aspects of the present disclosure may be practiced. The environment 100 includes a first vehicle 102, a second vehicle 104, traveler and/or trip information sources 108, a service provider 110, and a network 112. The network 112 may include any one or a combination of multiple different types of networks, such as cable networks, the Internet, wireless networks, and other private and/or public networks. In some instances, the network 112 may include cellular, Wi-Fi, or Wi-Fi direct. Any suitable network may be used herein.

The first vehicle 102 and the second vehicle 104 can include any vehicle that is capable of generating water or that may include water generating systems. The water generating capabilities may be part of the vehicle (e.g., integral) or separate systems. The present disclosure may refer to the first vehicle 102; however, it will be appreciated that the first vehicle 102 and second vehicle 104 can be similarly configured at least to generate water and communicate with the service provider 110 over the network 112. Descriptions of features of the first vehicle 102 can be applied to other vehicles disclosed herein. Any suitable number of vehicles may be used herein. The first vehicle 102 can include a vehicle controller 114, a water generation system 116, and a human-machine interface (HMI) 118. The water generation system 116 may be integral to the vehicle or a separate component of the vehicle.

The first vehicle 102 can be configured to communicate with the service provider 110 to receive and transmit data over the network 112. The vehicle controller 114 includes a processor and memory, and the memory stores instructions that can be executed by the processor. For example, the vehicle controller 114 can be configured to receive routes from the service provider 110, report data pertaining to the water generation system 116, and display information by the HMI 118.

The service provider 110 can include a server or cloud service that is configured to communicate with the traveler and/or trip information sources 108, as well as the vehicle controller 114 (and the vehicle controllers of each vehicle in a group as will be discussed herein). It will be understood that the features disclosed with respect to the service provider 110 can also be integrated into the vehicle controller 114 or another computing device localized at the vehicle level.

The service provider 110 can interface with a calendar application (an example traveler and/or trip information source). The service provider 110 can include an AI/ML engine 120 that analyzes water supplies and vehicle water generation and calculates water estimates for trips. The AI/ML engine 120 can also generate optimized groups and coordinate water sharing in these groups.

In certain embodiments, the service provider 110 can request access to, and connect to (if approved), a traveler's digital cloud-based calendar application (an example traveler and/or trip information source), to access travel-from (departure) and travel-to (destination) locations, and itinerary information, or the like. The traveler and/or trip data can be gathered from other locations as well. The traveler and/or trip data can be entered by the user via, e.g., the HMI at the vehicle or through a mobile application on a mobile device, or the like. Additionally, the service provider 110 can request access to and connects to (if approved), a traveler's digital cloud-based notes application(s), to determine water supply/provision stock (such as one case of bottled water, one gallon jug of water), as well as other itinerary information. Said information can also be provided by the user via, e.g., the HMI at the vehicle or through a mobile application on a mobile device, or the like.

When these data are gathered, the AI/ML engine 120 can predict water estimate(s) for the trip using data from previous trips of the traveler or from a group of other travelers in a digital community (which information can also be hosted by the service provider 110). The AI/ML engine 120 determines how much water is needed based on a review of the traveler's water supply/provisions, an amount of already generated water, and a predicted amount of water to be generated while driving to the destination based on route data and forecast weather reports (e.g., increased or decreased humidity along the route). In some instances, historical weather data can be used along with real-time data.

The AI/ML engine 120 can analyze past and current trip patterns (i.e., location, amount of water generated, rate of water generated, under what weather conditions the water was generated, weather forecast for current and upcoming trips, and an amount of water consumed) for the traveler. Similar trip data can be obtained from other travelers and analyzed, if available.

In addition, the AI/ML engine 120 can determine and use a water status of a group of other travelers in an “Oasis Community” who have agreed to share their data with the service provider 110 to help predict water generation capability data for future trips. Various strategies with the overarching ML categories (supervised, unsupervised, and reinforcement) can be employed by the AI/ML engine 120.

The service provider 110 can also be configured to collect the traveler's location, and amount of water generated in the past hours/minutes (or any other prior specified period of time), a rate of water generation currently in process in real-time, and the rate of water consumption in real-time. Again, these data are reported by the vehicle controller 114 when obtained from the water generation system 116.

The AI/ML engine 120 can also share where water generation and water generation rates are most favorable using data reported from travelers/vehicles. In addition, to build community, excess water that is generated by a vehicle may be identified and information indicative of that excess water can be shared with other travelers in the group. The AI/ML engine 120 can maintain a threshold value for the water estimate for the vehicle. For example, the AI/ML engine 120 can be configured to identify when the water availability for the trip is 20% more than what is required to complete the trip. When this is the case, the AI/ML engine 120 can identify this excess water capacity and suggest to the traveler that the excess water can be shared. In some instances, the AI/ML engine 120 can identify travelers who are in the same group, or travelers who are in proximity to the location the first vehicle 102 (e.g., within a certain number of miles of the first vehicle 102) who need water or are projected to have a shortfall of water. An unexpected shortfall of water can occur, for example, when ambient conditions or vehicle behavior results in a lower amount of water being produced than was initially determined.

In some instances, the system may direct travelers to other travelers with excess water. In other embodiments, the system may automatically redirect a traveler experiencing a shortfall of water on a different route which is likely to produce enough water (e.g., a route with higher humidity). Interactions with the traveler to identify excess water can include displaying messages to the traveler on the HMI 118, which may be at the vehicle or on an application on a mobile device. For example, the vehicle controller 114 can cause the display of a message to the traveler that excess water has been calculated. The vehicle controller 114 can query the traveler as to if they wish to share the excess water. If they approve, the service provider 110 can share this information with the second vehicle 104.

In some instances, the AI/ML engine 120 can also calculate the number of participants of a digital community (e.g., a group of travelers). The AI/ML engine 120 optimizes the number of participants in a given location at a given time, to mitigate “water mobs” or “water greed.” Participants are routed to locations that are optimized for their route but can also be structured in a way as to meet up with other travelers who are going to the same destination. The suggested routes to meet up with outer travelers is optional, and the ability to have the AI/ML engine 120 select a solitary route is possible.

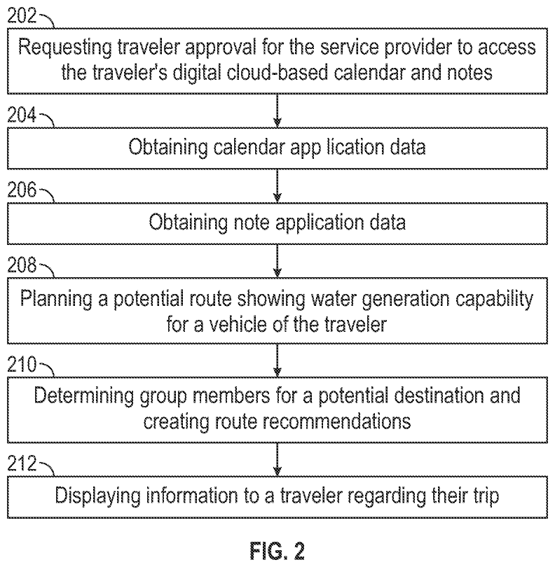

FIG. 2 illustrates an example flowchart in accordance with one or more embodiments of the present disclosure. The method can include a step 202 of requesting traveler approval for the service provider to access the traveler's digital cloud-based calendar and notes. The service provider can create a record or profile for the traveler. For example, the traveler may create a profile with the service provider. That is, the traveler may sign up with the service provider and provider their information to the service provider. The service provider may then be able to access various other applications and data associated with the traveler in order to build a profile of the traveler in the service provider's system.

The method can include a step 204 of obtaining calendar application data, along with a step 206 of obtaining note application data. The traveler can also indicate to the service provider what type of vehicle they have, which includes the type of water generating system of the vehicle. Generally, these resources provide trip information, as well as water supply information. The service provide may access this data via any suitable means. That is, the service provide may generate this information via one or more AI/ML systems or the user may provide said information to the service provider. Once these data are obtained, the method can include a step 208 of planning a potential route showing water generation capability for a vehicle of the traveler.

In some instance, the method can include a step 210 of determining group members for a potential destination and creating route recommendations. This can include scheduling and sending a meeting notice to the identified members.

The method can include a step 212 of displaying information to a traveler regarding their trip. The messages can be based on historical or crowd-sourced information. For example, if the destination was used before by the traveler, an HMI of the vehicle can display a message such as: “The last trip you took to your destination, water generation capacity (WGC) was good. I'm showing that WGC will still be good by the time we get there.” In another example, if recent water estimates were good at the proposed destination, an HMI of the vehicle can display a message such as: “During the last week, WGC at this location was good. I'm showing that it will still be good by the time we get there.” In yet another example, if recent water estimates were poor at the requested calendar location, an HMI of the vehicle can display a message such as: “We are heading to your destination, but I'm showing that WGC at that location is poor. Let's try a different route; here's one that I've selected for you, which has good WGC.”

If the current water inventory and water generation prediction are not likely to meet the needs of a given trip, an HMI of the vehicle can display a message such as: “We are heading to your destination, but I'm showing that the WGC at this location is poor. Based on your preferences, you don't want to take another route. And, based on your water inventory and the amount of water you used last time we were here, it's a good idea to stop and pick up some bottled water before we get going. I've found Last Chance Convenience Store (an example), which is nearby. I can tell from their website that they have bottled water in stock. I've scheduled our route to stop there before we get underway.” The service provider can transmit a signal to the navigation system of the vehicle to present an alternative navigation route to the traveler.

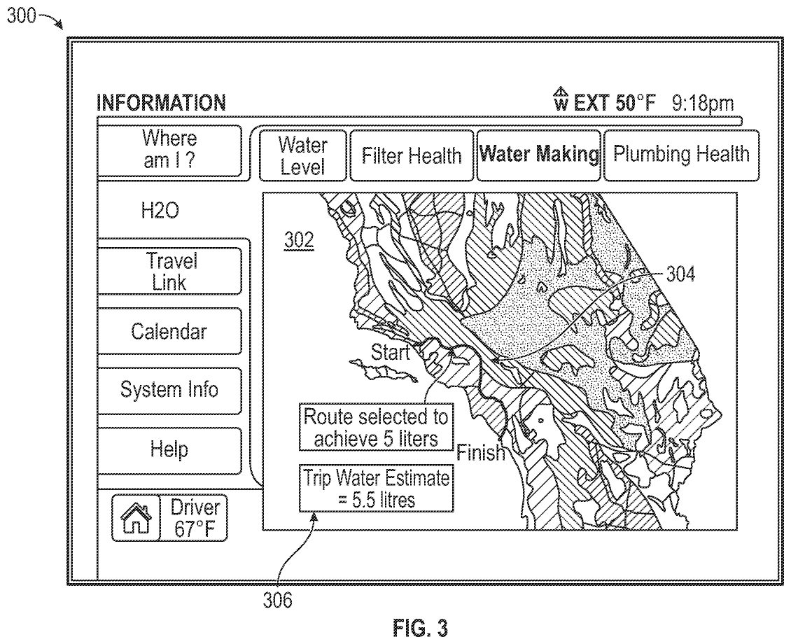

FIG. 3 is a screenshot of an example graphical user interface (GUI) pertaining to a travel route and water generation. The GUI 300 pertains to a water generation system of a vehicle. In this example, the GUI 300 includes a map 302 that highlights a calculated route 304 for a trip. The GUI 300 includes an indication that provides a water generation estimate 306. The water generation estimate can be determined based on the route of the trip, the forecasted weather conditions of the trip(s), and the water generation capabilities of the vehicle, among other factors. In this example, the start and finish locations were determined from the calendar and/or note applications. The service provider or water generation feature of the vehicle can calculate and provide these data to the traveler through the HMI.

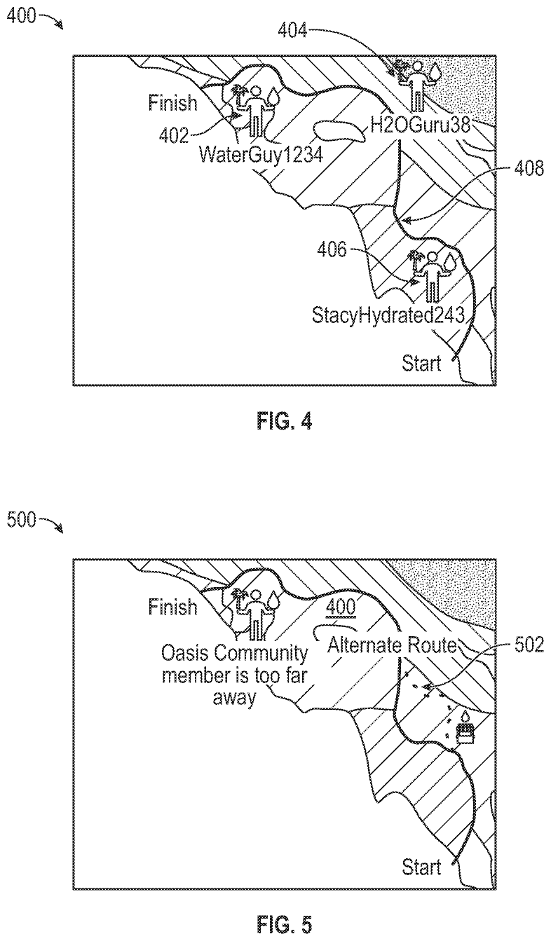

FIG. 4 is a screenshot of a map 400 provided on an example graphical user interface (GUI) that illustrates a group of travelers along the route having vehicles with water generation capabilities. The map 400 can illustrate a current location of other members in an optimized group, such as travelers 402, 404, and 406, who are located at various positions along a route 408. The user can use the map to determine and coordinate various meeting points with other travels who are generating water using their vehicles.

FIG. 5 is a screenshot of a map 500 provided on an example graphical user interface (GUI) that illustrates an alternative route 502. In certain embodiments, the alternative route 502 can be calculated when water production is determined to be lower than the water estimate predicted for completing the trip. Again, the water estimate can be based on historical trip data for a particular traveler or from a model generated from data of other travelers. Additionally, water generation can vary as ambient conditions change (e.g., humidity, elevation, etc.) or as the performance/output of the water generation system of the vehicle changes over time. When an unexpected drop in water generation is detected, the alternative route can be calculated and displayed to the traveler. In some instances, the alternative route 502 may be indicative of a route that is more like to generate (or procure through purchasing) sufficient water for the traveler. In determining the alternative route 502, the system may take other factors into consideration, such as fuel levels, fuel economy, wear and tear, etc.

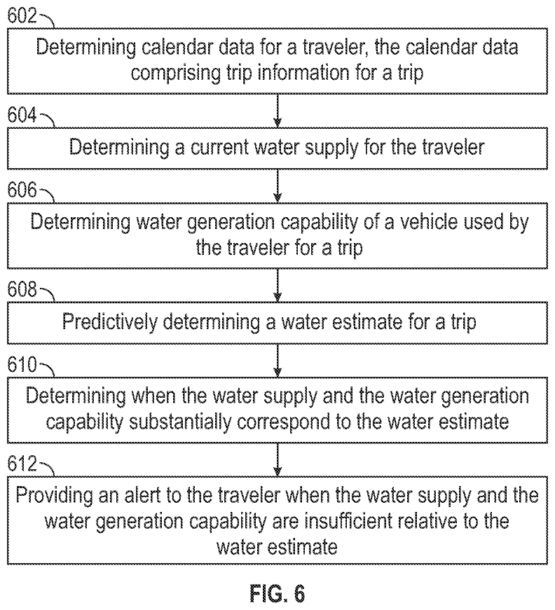

FIG. 6 is a flowchart of an example method of the present disclosure. The method can include a step 602 of determining calendar data for a traveler, the calendar data comprising trip information for a trip. The method can also include a step 604 of determining a current water supply for the traveler. This can include requesting access to a note taking application of the traveler to obtain the water supply level. As noted above, this can be determined from the traveler's application(s), or can be self-reported by the traveler into the HMI of the vehicle (or through a mobile application on a mobile device of the traveler).

The method can include a step 606 of determining water generation capability of a vehicle used by the traveler for a trip. This analysis can be based on historical trip data and prior water generation system performance. Next, the method can include a step 608 of predictively determining a water estimate for a trip, as well as a step 610 of determining when the water supply and the water generation capability substantially correspond to the water estimate. The method can include a step 612 of providing an alert to the traveler when the water supply and the water generation capability are insufficient relative to the water estimate. Also, alternative routes can be shared with the traveler. Alternatively routes can involve indicating where water can be purchased, as mentioned above.

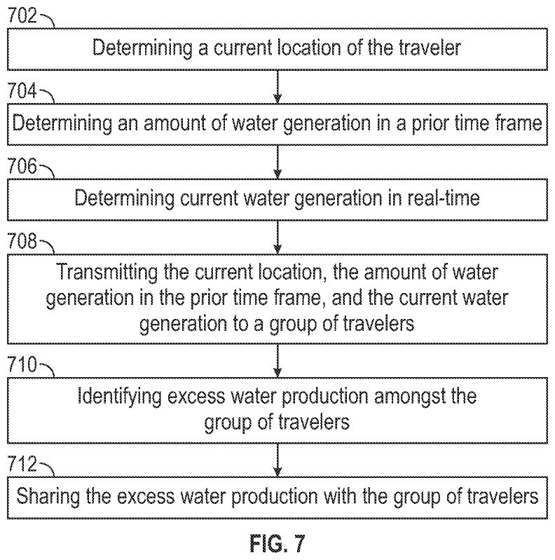

FIG. 7 is another example method of the present disclosure of assessing water generation capabilities and sharing the same with a group of travelers. The method can include a step 702 of determining a current location of the traveler. The method can also include a step 704 of determining an amount of water generation in a prior time frame. For example, water generation for a prior period of minutes or hours (could include any period of time) can be used.

Next, the method includes a step 706 of determining current water generation in real-time, as well as a step 708 of transmitting the current location, the amount of water generation in the prior time frame, and the current water generation to a group of travelers. In this way, the water status of travelers in a group can be shared. In some instances, the method can include a step 710 of identifying excess water production amongst the group of travelers as well as a step 712 of sharing the excess water production with the group of travelers.

Implementations of the systems, apparatuses, devices and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
determining, by a processor, trip information for a trip of a traveler;
determining, by the processor, a water supply for the traveler;
determining, by the processor, water generation capability of a vehicle used by the traveler for the trip;
determining, by the processor, a water estimate for the trip;
providing, by the processor and based on the water supply and the water generation capability being insufficient relative to the water estimate, a notification to the traveler.

2. The method according to claim 1, further comprising requesting, by the processor, access to an application of the traveler to obtain calendar data, the calendar data comprising departure and arrival locations used to determine the trip information.

3. The method according to claim 1, further comprising requesting, by the processor, access to an application of the traveler to obtain the water supply of the traveler.

4. The method according to claim 1, further comprising:
determining, by the processor and during the trip, a current location of the traveler;
determining, by the processor, an amount of water generation in a prior time frame;
determining, by the processor, current water generation in real-time; and
transmitting, by the processor, the current location, the amount of water generation in the prior time frame, and the current water generation to a group of travelers.

5. The method according to claim 4, further comprising determining, by the processor, water generation rates of the group of travelers.

6. The method according to claim 5, further comprising:
identifying, by the processor, excess water production amongst the group of travelers; and
sharing, by the processor, the excess water production with the group of travelers.

7. The method according to claim 1, further comprising optimizing, by the processor, a number of a group of travelers by:
determining the travelers having a common destination based on the trip information for the group of travelers;
generating a recommended route to the common destination for each of the group of travelers; and
transmitting the recommended route to each of the group of travelers.

8. The method according to claim 1, further comprising providing, by the processor, a message to the traveler when water estimates for other travelers to a destination indicate that the water estimate is sufficient for the trip.

9. The method according to claim 1, further comprising providing, by the processor, a message to the traveler when water estimates for other travelers indicates that the water estimate is insufficient for the trip.

10. The method according to claim 1, further comprising providing, by the processor, a message to the traveler when the water estimate is insufficient of a location where additional water is available or an alternative route is available.

11. A system comprising:
a vehicle having a vehicle controller and a water generation system;
a processor and memory, the processor configured to:
determine information for a trip of a traveler;
determine a water supply for the traveler;
determine water generation capability of the vehicle used by the traveler for the trip;
determine a water need for the trip;
determine that the water supply and the water generation capability do not meet the water need for the trip; and
provide an alternative route to a destination of the trip to ensure the water need for the trip is met.

12. The system according to claim 11, further comprising requesting access to an application of the traveler to obtain calendar data, the calendar data comprising departure and arrival locations used to determine the trip information.

13. The system according to claim 11, further comprising requesting access to an application of the traveler to obtain the water supply of the traveler.

14. The system according to claim 11, further comprising:
determining, during the trip, a current location of the traveler;
determining an amount of water generation in a prior time frame;
determining current water generation in real-time; and
transmitting the current location, the amount of water generation in the prior time frame, and the current water generation to a group of travelers, the group of travelers including the traveler.

15. The system according to claim 14, further comprising determining water generation rates of the group of travelers.

16. A vehicle comprising:
a water generation system;
a controller configured to:
determine information for a trip of a traveler;
determine a water supply for the traveler;
determine water generation capability of the water generation system;
determine a water need for the trip;
determine that the water supply and the water generation capability do not meet the water need for the trip; and
providing an alternative route to a destination of the trip to ensure the water need for the trip is met.

17. The vehicle according to claim 11, further comprising requesting access to an application of the traveler to obtain calendar data, the calendar data comprising departure and arrival locations used to determine the trip information.

18. The vehicle according to claim 11, further comprising requesting access to an application of the traveler to obtain the water supply of the traveler.

19. The vehicle according to claim 11, further comprising:
determining, during the trip, a current location of the traveler;
determining an amount of water generation in a prior time frame;
determining current water generation in real-time; and
transmitting the current location, the amount of water generation in the prior time frame, and the current water generation to a group of travelers.

20. The vehicle according to claim 14, further comprising determining water generation rates of the group of travelers.
